(19) United States
(12) Patent Application Publication
(10) Pub. No.: US 2013/0068693 A1
(43) Pub. Date: Mar. 21, 2013

(54) SOLID PHASE EXTRACTION MEDIA

(71) Applicants: Andrew W. Rabins, St. Paul, MN (US); Kannan Seshadri, Woodbury, MN (US); Gary F. Howorth, Oakdale, MN (US); Gezahegn D. Damte, Cottage Grove, MN (US)

(72) Inventors: Andrew W. Rabins, St. Paul, MN (US); Kannan Seshadri, Woodbury, MN (US); Gary F. Howorth, Oakdale, MN (US); Gezahegn D. Damte, Cottage Grove, MN (US)

(73) Assignee: 3M INNOVATIVE PROPERTIES COMPANY, ST. PAUL, MN (US)

(21) Appl. No.: 13/700,930

(22) PCT Filed: Jun. 6, 2011
(86) PCT No.: PCT/US2011/039233

§ 371 Date: Nov. 29, 2012

Related U.S. Application Data
(60) Provisional application No. 61/352,418, filed on Jun. 8, 2010.

(51) Int. Cl. B01J 20/26; B01D 15/00; B01J 20/30

(52) U.S. Cl. CPC B01J 20/261; B01J 20/26; B01J 20/3042; B01D 15/00
USPC 210/660; 502/401

(57) ABSTRACT

Described herein is a low back-pressure, solid phase extraction media for removing dissolved metals in a liquid. The solid phase extraction media comprises particles entrapped in a porous polymeric fiber matrix. The particles comprise at least one of a thiol-containing moiety or a thiourea-containing moiety, and the porous polymeric fiber matrix comprises a plurality of fibers and a polymeric binder.

### TECHNICAL FIELD

A low back-pressure, solid phase extraction media for removing dissolved metals in a liquid is described.

### BACKGROUND

Recently the U.S. Food & Drug Administration lowered the level of catalysts in an approved pharmaceutical ingredient down to 5 ppm (part per million). (Semi)precious metals such as Palladium (Pd) and Platinum (Pt) are used to catalyze key reactions in traditional chemical pharmaceutical synthesis. Typically the catalysts are in a homogenous (dissolved) form and are added to the synthesis to enable the desired reaction. Regulatory agencies, such as the Food & Drug Administration, have standards related to the permissible level of catalyst allowed in an approved pharmaceutical ingredient. Therefore, manufacturers will treat (or purify) the reaction product to remove the (semi)precious metals.

Usually after the final synthesis step, the reaction solution or mixture containing the reaction product is contacted with an adsorbent material to remove the (semi)precious metals. Typically, this is done via a batch process.

In one example, loose adsorbent particles are added to the reaction solution or mixture. The resulting mixture may be agitated to increase the contact between the (semi)precious metal and the active sites on the adsorbent particles. After a period of time, the adsorbent particles containing the catalyst are filtered out, leaving the reaction solution or mixture now free of catalyst, which may then be further processed/purified to isolate the desired product.

Alternatively, because the loose adsorbent particles may be difficult to handle, the adsorbent particles may be contained (or packed) in a column, which the reaction solution or mixture is passed through, resulting in an effluent (or flow-through) containing the desired product now free of catalyst.

### SUMMARY

There is a desire to find processes for removal of catalysts from reaction mixtures or solutions that are less time consuming and more efficient (i.e., higher throughput). It may also be desirable to identify an article that can adsorb metal ions, especially heavy metal ions in non-aqueous environments.

In one aspect, a low back-pressure, solid phase extraction media for removing dissolved metals in a liquid is disclosed comprising: a porous polymeric fiber matrix comprising a plurality of fibers and a polymeric binder; and particles comprising at least one of a thiol-containing moiety or a thiourea-containing moiety, wherein the particles are entrapped in the porous polymeric fiber matrix.

In one embodiment, the solid phase extraction media of the present disclosure comprises particles having a diameter of less than 75 μm is disclosed.

In another embodiment, the solid phase extraction media of the present disclosure, having a differential back pressure of 1.5 psi (10.3 kPa) at a flowrate of 3 ml/cm² is disclosed.

In yet another embodiment, the solid phase extraction media of the present disclosure having particles mechanically entrapped in the porous polymeric fiber matrix is disclosed.

In another aspect, a method for removing metals dissolved in a liquid is disclosed comprising: (a) providing the low back-pressure solid phase extraction media of the present disclosure; and (b) contacting the low back-pressure solid phase extraction media with a liquid comprising a dissolved metal, wherein the metal is adsorbed and becomes bound to at least one of the particles.

In another aspect, a method of making solid-phase extraction media is disclosed comprising: (a) dispersing fibers in water to form a first aqueous dispersion; (b) adding a dispersed binder to the first aqueous dispersion; (c) coagulating the binder onto the dispersed fibers to form a second aqueous dispersion; (d) contacting the second aqueous dispersion with particles comprising at least one of a thiol-containing moiety or a thiourea-containing moiety to from a third aqueous dispersion; and (e) removing the liquid from the third aqueous dispersion.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

In the present disclosure, a porous fiber matrix is used to entrap particles comprising at least one of a thiol-containing moiety or a thiourea-containing moiety to form a solid phase extraction media. Liquids comprising dissolved metals are passed through the solid phase extraction media and the dissolved metals are removed.

The solid phase extraction media of the present disclosure includes polymeric fibers, polymeric binder, and particles comprising at least one of a thiol-containing moiety or a thiourea-containing moiety.

Generally, the polymeric fibers that make up the porous polymeric fiber matrix of the solid phase extraction media of the present disclosure can be any pulpable fiber. Preferred fibers are those that are stable to radiation and/or to a variety of solvents.

The polymeric fibers may be formed from any suitable thermoplastic or solvent dispersible polymeric material. Suitable polymeric materials include, but are not limited to, fluorinated polymers, chlorinated polymers, polyolefins, poly(isoprenes), poly(butadienes), polyamides, polyimides, polyethers, poly(ether sulfones), poly(sulfones), poly(vinyl acetates), copolymers of vinyl acetate, poly(phosphazenes), poly(vinyl esters), poly(vinyl ethers), poly(vinyl alcohols), polyaramids, poly(carbonates), and combinations thereof.

Suitable fluorinated polymers include, but are not limited to, poly(vinyl fluoride), poly(vinylidene fluoride), copolymers of vinylidene fluoride (such as poly(vinylidene fluoride-co-hexafluoropropylene), and copolymers of chlorotrifluoroethylene (such as poly(ethylene-co-chlorotrifluoroethylene).

Suitable polyolefins include, but are not limited to, poly(ethylene), poly(propylene), poly(l-butene), copolymers of ethylene and propylene, alpha olefin copolymers (such as copolymers of ethylene or propylene with 1-butene, 1-hexene, 1-octene, and 1-decene), poly(ethylene-co-1-butene) and poly(ethylene-co-1-butene-co-1-hexene).

Suitable polyamides include, but are not limited to, nylon 6; nylon 6,6; nylon 6,12; poly(iminoadipoyliminohexamethylene); poly(iminoadipoyliminodecamethylene); and polycaprolactam.

Suitable polyimides include, but are not limited to, poly(pyromellitimide).

Suitable poly(ether sulfones) include, but are not limited to, poly(diphenylether sulfone) and poly(diphenylsulfone-co-diphenylene oxide sulfone).

Suitable copolymers of vinyl acetate include, but are not limited to, poly(ethylene-co-vinyl acetate) and such copolymers in which at least some of the acetate groups have been hydrolyzed to afford various poly(vinyl alcohols) including, poly(ethylene-co-vinyl alcohol).

Suitable polyaramids include, for example, those fibers sold under the trade designation “KEVLAR” by DuPont Co., Wilmington, Del. Pulps of such fibers are commercially available in various grades based on the length of the fibers that make up the pulp such as, for example, “KEVLAR 1F306” or “KEVLAR 1F694”, both of which include aramid fibers that are at least 4 mm in length.

In one embodiment, the polymeric fiber matrix further comprises natural or inorganic fibers. Exemplary natural fibers include cellulose and cellulose derivatives. Exemplary inorganic fibers include fiberglass (such as E-glass or S-glass), ceramic fibers (e.g., ceramic oxides, silicon carbide, and alumina fibers), boron fibers (e.g., boron nitride, and boron carbide), or combinations thereof. Ceramic fibers are crystalline ceramics (i.e., exhibits a discernible X-ray powder diffraction pattern) and/or a mixture of crystalline ceramic and glass (i.e., a fiber may contain both crystalline ceramic and glass phases).

To ensure adequate support and structural integrity of the porous fiber matrix, at least some of the fibers may comprise an adequate length and diameter. For example, a length of at least 2 mm, 3 mm, 4 mm, 6 mm, 8 mm, 10 mm, 15 mm, 20 mm, 25 mm, or even 30 mm, and a diameter of at least 10 μm (micrometer), 20 μm, 40 μm, or even 60 μm.

To entrap the sulfur-containing particles and/or ensure a high surface area material, the fibers may comprise a main fibers surrounded by many smaller attached fibrils. The main fiber generally can have a length in the range of 0.8 mm to 4 mm, and an average diameter between 1 to 20 micrometers. The fibrils typically have a submicrometer diameter.

To enhance the performance, the porous polymeric fiber matrix may comprise two, three, four, or even more different fibers. For example, a nylon fiber may be added for strength and integrity, while fibrillated polyethylene may be added for entrapment of the particulates. If fibrillated and non-fibrillated fibers are used, generally, the weight ratio of fibrillated fibers to non-fibrillated fibers is at least 1:2, 1:1, 2:1, 3:1, 5:1, or even 8:1.

The solid phase extraction media of the present disclosure is prepared in a wetlaid process as will be described below. During processing, the polymeric fibers are dispersed in a dispersing liquid to form a slurry. In one embodiment, the polymeric fibers may comprise additives or polymeric groups to assist in the fiber's dispersion. For example, polyolefins-based fibers may contain groups such as maleic anhydride or succinic anhydride, and during the melt-processing of polyethylene fibers, a suitable surfactant may be added to assist in the dispersion of the polymeric fibers.

Regardless of the type of fiber(s) chosen to make up the pulp, the relative amount of fiber in the resulting solid phase extraction media (when dried) is preferably at least 10%, 12%, 12.5%, 14%, 15%, 18%, 20%, or even 22% by weight; at most 20%, 25%, 27%, 30%, 35%, or even 40% by weight.

A polymeric binder is added to the fibrous pulp to bind the fibers, forming the polymeric fiber matrix. Useful polymeric binders are those materials that are stable and that exhibit little or no interaction (i.e., chemical reaction) with either the fibers of the pulp or the particles entrapped therein. Natural and synthetic polymeric materials, originally in the form of latexes, may be used. Common examples of useful binders include, but are not limited to, natural rubbers, neoprene, styrene-butadiene copolymer, acrylate resins, polyvinyl chloride, and polyvinyl acetate.

In the present disclosure, particles that remove metals are entrapped in the porous fiber matrix. Particles useful in the present disclosure are those comprising at least one thiol-containing moiety and/or at least one thiourea-containing moiety. These sulfur-containing moieties (i.e., thiol- and thiourea-containing moieties) trap the dissolved metals, removing them from the liquid as it is passed through the solid phase extraction media. The mechanism for entrapment of the metal may be through an ionic interaction or formation of a complex. The complex may be formed through the interaction of a single ligand, or a multidentate interaction such as chelation interaction, involving either a single ligand or multiple ligands on the same or different molecule.

In one embodiment, the particles of the present disclose are porous. In one embodiment, the particles of the present disclose are not porous.

In one embodiment, the thiol-containing moiety has the general formula:

—RSH

wherein R is an alkyl, alkenyl, aryl, or alkaryl group, optionally comprising heteroatoms (such as S, Br, Cl, etc.) and/or other functional groups including, for example, ethers, esters, amines, carbonyls, triazine, and combinations thereof.

Exemplary thiol-containing moieties include: —(CH₂)ₙSH; —(CH₂)ₙNH(CH₂)ₙSH; —(CH₂)ₙS(CH₂)ₙSH; —(CH₂)ₙNH(C₃N₃(SH)ₘ); and —(CH₂)ₙNHC[(CH₂)ₙSH]C═OO⁻; where n, independently is at least 0, 2, 3, 4, 6, or even 8; at most 8, 10, 12, 16 or even 20; m is 1 or 2.

In one embodiment, the thiourea-containing moiety has the general formula:

—R₁NHC(═S)NHR₂

wherein R₁ and R₂ may be the same or different and are an alkyl, alkenyl, aryl, or alkaryl group, optionally comprising heteroatoms (such as S, Br, Cl, etc.) and/or other functional groups including, for example, ethers, esters, amines, carbonyls, triazine, and combinations thereof.

An exemplary thiourea-containing moiety includes: —(CH₂)ₙNH C(S)NH(CH₂)ₙCH₃where n, independently is at least 0, 2, 3, 4, 6, or even 8; at most 8, 10, 12, 16 or even 20.

Such particles comprising a sulfur-containing moiety are commercially available from, for example, Silicycle Inc., Quebec City, Canada; Steward Inc., Chattanooga, Tenn.; and PhosphonicS Ltd., United Kingdom.

Particles useful in the present disclosure preferably have an average diameter of less than 75, 50, 25, 20, 15 or even 10 μm; more than 2, 5, 10, 15, or even 20 μm. In one embodiment, the effective average diameter of the particles is at least 125 times smaller than the uncalendered thickness of the sheet, preferably at least 175 times smaller than the uncalendered thickness of the sheet, more preferably at least 200 times smaller than the uncalendered thickness of the sheet.

Because the capacity and efficiency of the solid phase extraction media depends on the amount of particles (i.e., particles comprising a sulfur-containing moiety) included therein, high particle loading is desirable. The relative amount of particles in a given solid phase extraction media of the present disclosure may be at least 50, 60, 70, 80, 85 or even 90 weight % based on the total weight of the solid phase extraction media.

The particles used in the solid phase extraction media of the present disclosure, are mechanically entrapped or entangled in the polymeric fibers of the porous polymeric pulp. In other words, the particles are not covalently bonded to the fibers.

The solid phase extraction media of the present disclosure can also include one or more adjuvants. Useful adjuvants include those substances that act as process aids and those substances that act to enhance the overall performance of the resulting solid phase extraction media. Examples of the former category include sodium aluminate and aluminum sulfate, which help to precipitate binder into the pulp, When used, relative amounts of such adjuvants range from more than zero up to about 0.5% (by weight), although their amounts are preferably kept as low as possible so as not to take away from the amount of particles that can be added.

Solid phase extraction media of the present disclosure are prepared via a wetlaid process. The chopped fiber is blended in a container in the presence of a dispersing liquid, such as water, or water-miscible organic solvent such as alcohol or water-alcohol. The amount of shear used to blend the mixture has not been found to affect the ultimate properties of the resulting solid phase extraction media, although the amount of shear introduced during blending is preferably high. Thereafter, particles, binder (in the form of a latex) and an excess of a pH adjusting agent such as alum, which acts to precipitate the binder, are added to the container. If a solid phase extraction media is to be made by hand-sheet methods known in the art, the order that these three ingredients are added does not significantly affect ultimate performance of the solid phase extraction media. However, addition of binder after addition of particles can result in a solid phase extraction media where binder is more likely to adhere the particles to the fibers of the solid phase extraction media. Also, if a solid phase extraction media is to be made by a continuous method, the three ingredients must be added in the listed order. (The remainder of this discussion is based on the hand-sheet method, although those skilled in the art can readily recognize how to adapt that method to allow for a continuous process.)

After the particles, binder, and pH adjusting agent are added to the fiber-liquid slurry, the overall mixture is poured into a mold, the bottom of which is covered by a screen. The dispersing liquid (e.g., water) is allowed to drain from the wet sheet through the screen. After sufficient liquid has drained from the sheet, the wet sheet normally is removed from the mold and dried by pressing, heating, or a combination of the two. Normally, pressures of 300 to 600 kPa and temperatures of 100 to 200° C., preferably 100° to 150° C., are used in these drying processes.

The dried sheet may have an average thickness of at least 0.2, 0.5, 0.8, 1, 2, 4, or even 5 mm; at most 5, 8, 10, 15, or even 20 mm. Up to 100 percent of the liquid can be removed, preferably up to 90 percent. Calendering can be used to provide additional pressing or fusing, when desired.

Sheet materials comprising polyaramids are particularly useful when radiolytic, hydrolytic, thermal, and chemical stability are desired. In most cases, such materials will exhibit resistance to swelling when exposed to solvents. Sheet materials comprising polyaramids are particularly useful for removal of radioactive species from liquids because of their resistance to deterioration under the influence of radiation from radioactive decay.

The solid phase extraction media of the present disclosure comprise a polymeric fiber matrix and particles comprising a sulfur-containing moiety (i.e., a thiol-containing or a thiourea-containing moiety), have controlled porosity, and preferably have a Gurley time of at least 0.1 second, preferably at least 2-4 seconds, and more preferably at least 4 seconds for 100 mL of air. The basis weight of the sheet materials can be in the range of 250 to 5000 g/m², preferably in the range of 400 to 1500 g/m², most preferably 500 to 1200 g/m².

Desirably, the average pore size of the uniformly porous sheet material can be in the range of 0.1 to 10 micrometers as measured by scanning electron microscopy. Void volumes in the range of 20 to 80% can be useful, preferably 40 to 60%. Porosity of the sheet materials can be modified (increased) by including fibers of larger diameter or stiffness with the mixture to be blended.

Although a binder is added to the composition to hold the porous polymeric matrix together, an effective amount of binder is used, such that the porous polymeric matrix is held together while not coating the active sites on the particles (i.e., the thiol or thiourea). In the present disclosure, it has been discovered that low amounts of binder are sufficient to hold the fibers together. Unexpectedly, the relative amount of binder in the resulting solid phase extraction media (when dried) may be less than 5, 4, 3, 2, or even 1% by weight relative to the weight of the fibers.

In one embodiment, the binder does not substantially adhere to the particle. In other words, when the solid phase extraction media is examined by scanning electron microscopy, less than 5%, 4%, 3%, 2% or even 1% of total surface area of the particles is covered with binder.

Once made, the solid phase extraction media of the present disclosure can be cut to the desired size and used as is. If desired (e.g., where a significant pressure drop across the sheet is not a concern), the solid phase extraction media can be calendered so as to increase the tensile strength thereof. (Where the solid phase extraction media is to be pleated, drying and calendering preferably are avoided.)

The solid phase extraction media of the present disclosure may be flexible (i.e., able to be rolled around a 0.75 inch (about 2 cm) diameter core). This flexibility may enable the solid phase extraction media to be pleated or rolled.

The solid phase extraction media of the present disclosure may be used to remove dissolved metals from liquids while providing low back pressure.

Dissolved metals that may be removed, include, but are not limited to, precious metals, semi-precious metals and heavy metals. Exemplary metals include: mercury, palladium, platinum, gold, silver, and copper. Optionally, the metals may be radioactive. The metals may be in concentrations of at least 0.5, 1, 5, 10, 20 or 50 ppm; at most 1000, 3000, 5000, or even 10000 ppm in the liquid.

The liquid the metal is dissolved in may be aqueous or non-aqueous. In one embodiment, the dissolved metal may be in an ionic form. Advantageously, the dissolved metals may be removed from non-aqueous liquids. In other words, liquids which comprise less than 0.5, 1, or even 5% by weight of water or polar solvents. Often times, metal ions are removed using an ion exchange process, however, in ion exchange, typically, aqueous liquids are needed to make the components ionic. The present disclosure provides an extraction medium that works well in both aqueous and non-aqueous environments.

The solid phase extraction media of the present disclosure has a low back pressure, meaning that a high volume of liquid can be quickly passed through the solid phase extraction media without generating high back pressure. A low back pressure refers to a differential back pressure of less than 3 pounds per square inch (20.7 kPa), 2.5 (17.2), 2 (13.8), 1.5 (10.3), or even 1 (6.9) at 3ml/cm² flowrate, wherein the flowrate is based on the frontal surface area.

The solid phase extraction media may be capable of removing at least 40, 50, 55, 60, 65, or even 75%: at most 75, 80, 85, 90, 95, 98, or even 99% of the targeted metal ion in a single layer. Alternatively, multiple layers of solid phase extraction media may be used to allow for improved removal rates.

Generally when performing typical batch extraction, particle sizes of 50 μm or larger are required. If using a packed column such as in preparatory liquid chromatography column, particle sizes of 60-90 micrometers are typically used to prevent excessive pressure drop. Smaller sized particles (5 μm or smaller) are known to be used in analytical high pressure liquid chromatography columns, however small columns are typically used to prevent excessive pressure. Thus, large volumes of liquids (e.g., liters) are time consuming to pass through these analytical chromatography columns.

One significant advantage of the porous fiber matrix of the present disclosure is that very small particle sizes (10 μm or smaller) and/or particles with a broad size distribution can be employed. This allows for excellent one-pass kinetics, due to increased surface area/mass ratios and for porous particles, minimized internal diffusion distances. Because of the relatively low pressure drops observed in the solid phase extraction media of the present disclosure, a minimal driving force such as using gravity or a vacuum, can be used to pull the liquid through the solid phase extraction media, even when small particle sizes are employed.

The solid phase extraction media of the present disclosure may allow for a rapid means of reducing metal ion content in liquids and/or potentially eliminate one or more process steps. As the solid phase extraction media of the present disclosure is a self-contained device, it may eliminate several process steps inherent in batch extraction with loose powder: chiefly, filtering out the adsorbent, as well as decontaminating the chemical reactor or storage vessel from the adsorbent after the batch has been drained.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

These abbreviations are used in the following examples: g=gram, kg=kilograms, min=minutes, mol=mole; cm=centimeter, mm=millimeter, ml=milliliter, L=liter, psi=pounds per square inch, ppm=parts per million, kPa=kiloPascals, rpm=revolutions per minute, and wt=weight.

TABLE 1
Table of Materials

| Name | Description |
|---|---|
| Polyethylene | Sold under the trade designation “FYBREL |
| fibers 1 | PEFYB-00E620” available from Minifibers, Inc, |
| | Johnson City, TN. |
| Polyethylene | Sold under the trade designation “FYBREL- |
| fibers 2 | 00E400” available from Minifibers, Inc, Johnson |
| | City, TN. |
| Nylon fibers | Sold under the catalog #NYT66-0102RR-0600 |
| | available from Minifibers, Inc, Johnson City, TN. |
| Long strand | Sold under the trade designation “MICRO- |
| fiberglass | STRAND 106-475” available from Schuller, Inc, |
| | Denver, CO. |
| Latex binder | A ethylene-vinyl acetate acrylic co-polymer (about |
| | 55% solids) sold under the trade designation |
| | “AIRFLEX BP600” available from Air Products |
| | Polymers, Allentown, PA. |
| Flocculant | Sold under the trade designation “MIDSOUTH |
| | 9307” available from Midsouth Chemical Co, Inc, |
| | Ringgold, LA. |
| Particle 1 | Sold under the trade designation “SILIABOND- |
| | THIOL” available from Silicycle, Inc., Quebec |
| | City, Canada. |
| Particle 2 | Sold under the trade name “THIOL-SAMMS |
| | THMS-04” available from Steward, Inc., |
| | Chattanooga, TN. |
| Ethanol | Standard Grade, 94-96% pure, available from Alfa |
| | Aesar, Ward Hill, MA. |
| Methanol | Environmental grade 99.8%+ Pure, available from |
| | Alfa Aesar, Ward Hill, MA. |
| Toluene | 99.7% pure available from Alfa Aesar is a division |
| | of Johnson Matthey, Ward Hill, MA. |
| Palladium(II) | ≧99.9% pure, available from Sigma Aldrich, St. |
| Acetate | Louis, MO. |

### Examples 1-2

The premix was prepared by blending polyethylene fibers 1, nylon fibers, long strands Fiberglass, and 4 L of cold tap water inside a blender (M/N 37BL84, available from Waring Inc, Torrington, Conn.) at medium speed for 120 seconds. The premix was then inspected to ensure that the fibers had been uniformly dispersed and no nits or clumps remained. 500 ml of the premix was poured into a 1 L glass beaker and the mixer (Stedfast Stirrer SL2400, available from Fisher Scientific, Hampton, N.H.) with a marine type impeller was turned on at a speed setting of 4 for five minutes. The latex binder is predispersed in 25 ml of tap water in a 50 ml beaker, and then added to the premix. This was followed by rinsing out the 50 ml beaker with another 25 ml of water. After 2 minutes flocculant was added in a similar fashion to cause the latex binder to precipitate out of solution onto the fibers. This is visually apparent, as the liquid phase of the premix changes from cloudy to clear.

Particle 1 was then added to the batch and allowed to mix for one minute. This batch was then poured into the 8″ Handsheet Former apparatus (available from Williams Apparatus Co, Watertown, N.Y.) comprising a 8 inch (20 cm) square box with a 80 mesh screen as the bottom. Prior to adding the batch of wetlaid slurry, the apparatus was filled with tap water to a level approximately 1 cm above the screen. Once the batch was added, a vacuum was created by immediately opening the drain on the apparatus, which pulled the water out of the box. The resulting wetlaid was roughly 2 mm thick, but was still saturated with water.

The wetlaid felt was then removed from the apparatus by transferring it onto a sheet of blotter paper (8″×8″ #96 white, available from Anchor Paper, St. Paul, Minn.). The wetlaid felt and blotter paper was sandwiched between several more layers of blotter paper and pressed in an air powered press set at 60 psi (413 kPa) (available from Mead Fluid Mechanics) between two reinforced screens, which resulted in approximately 12 psi (83 kPa) pressure exerted on the wetlaid felt. The wetlaid felt was left in the press for 1-2 minutes until no further water was observed being expelled. The pressed felt was then transferred onto a fresh sheet of blotter paper and placed in an oven (trade designation “STABIL-THERM” model OV-560A-2, available from Blue M Corp., Blue Island, Ill.) at 150° C. for 40 minutes to obtain the solid phase extraction material. Shown in Table 2 are the amounts of materials added to Examples 1 and 2, the resulting weight of the solid phase extraction material after being dried, and the % particles comprising a thiol-containing moiety (determined empirically based on the weight of the particles comprising a thiol-containing moiety added versus weight of the dried sheet (i.e., the solid phase extraction media).

TABLE 2

| | Example 1 | Example 2 |
|---|---|---|
| Polyethylene fibers 1 | 4.0 g | 4.0 g |
| Nylon fibers | 2.0 g | 2.0 g |
| Long strand Fiberglass | 1.5 g | 1.5 g |
| Latex binder | 0.78 g | 0.83 g |
| Flocculant | 1.66 g | 1.83 g |
| Particle 1 | 15.0 g | 20.45 g |
| Resulting weight | 17.58 g | 22.39 g |
| % particles | 76.8% | 79.0% |

### Examples 3-5

The premix was prepared by blending polyethylene fibers 2, nylon fibers, long strand Fiberglass, and 4 L of cold tap water inside a blender (M/N 37BL84, available from Waring Inc., Torrington, Conn.) at medium speed for 120 seconds. The premix was then inspected to ensure that the fibers had been uniformly dispersed and no nits or clumps remained. 500 ml of this premix was poured into a 1 L glass beaker and the mixer (Stedfast Stirrer SL2400, available from Fisher Scientific, Hampton, N.H.) with a marine type impeller was turned on at a speed setting of 4 for five minutes. Predispersed in 25 ml of tap water in a 50 ml beaker, a latex binder was added. This was followed by rinsing out the 50 ml beaker with another 25 ml of water. After 2 minutes flocculant was added in a similar fashion to cause the latex binder to precipitate out of solution onto the fibers. This is visually apparent, as the liquid phase of the premix changes from cloudy to clear.

Particle 2 premix was prepared by adding 200.2 g of particle 2 to a 4 L beaker containing 600 g of ethanol and 1210 g of deionized water. This was mixed for 30 minutes on an IKA-Werke mixer (available from VWR, Inc., Westchester, Pa.) at 500 rpm. Additional methanol was added to the batch to make up for evaporation. The 300 ml of the Particle 2 premix was then added to the wetlaid slurry and allowed to mix for one minute. This batch was then poured into the 8″ Handsheet Former apparatus (available from Williams Apparatus Co, Watertown, N.Y.). Prior to adding the batch of wetlaid slurry the apparatus was filled with tap water to a level approximately 1 cm above the screen. Once the batch was added, a vacuum was created by immediately opening the drain on the apparatus, which pulled the water out of the box.

The wetlaid felt was then removed from the apparatus by transferring it onto a sheet of blotter paper. This material was sandwiched between several layers of blotter paper and pressed in an air powered press set at 60 psi (413 kPa) between two reinforced screens, which was approximately 12 psi (83 kPa) pressure exerted on the wetlaid felt. The material was left in the press for 1-2 minutes until no further water was observed being expelled. The pressed felt was then transferred onto a fresh sheet of blotter paper and placed in an oven (trade designation “STABIL-THERM” model OV-560A-2, available from Blue M Corporation, Blue Island, Ill.) at 150° C. for 40 minutes to obtain the solid phase extraction material. Shown in Table 3 are the amounts of materials added to Examples 3-5, the resulting weight of the solid phase extraction material after being dried, and the % by weight of particles comprising a thiol-containing moiety.

TABLE 3

| | Example 3 | Example 4 | Example 5 |
|---|---|---|---|
| Polyethylene fibers 2 | 12.80 g | 12.80 g | 12.55 g |
| Nylon fibers | 3.14 g | 3.14 g | 3.0 g |
| Long strand Fiberglass | 5.0 g | 5.0 g | 5.0 g |
| Latex binder | 2.87 g | 2.36 g | 2.15 g |
| Flocculant | 4.83 g | 4.65 g | 4.76 g |
| Resulting weight | 41.33 g | 40.95 g | 43.00 g |
| % particles | 86.2% | 85.4% | 90.4% |

### Example 6

First, a calibration curve was generated by preparing a master solution of a 600 ppm palladium acetate in toluene. Eight calibration standards were made spanning 50 to 600 ppm palladium. The samples were analyzed, in duplicate, on an UV-vis spectrophotometer (model 8453, available from Agilent Technologies, Santa Clara, Calif.) blanked with toluene at a wavelength from 390-400 nm. The calibration curve had a correlation coefficient of 0.996.

A 25 mm disk of solid phase extraction media containing the solid phase extraction media from Example 1 was placed in a 25 mm syringe membrane holder (made of Delrin plastic, available from Pall, Inc., Port Washington, N.Y.). Given that this solid phase extraction media contained 0.085 g of Particle 1 per cm², this equates to 0.322 g of Particle 1 used (The wetted area of media in the holder corresponds to a diameter of 22 mm).

The holder containing the solid phase extraction media was then connected to a peristaltic pump (model 5201, available from Heidolph-Brinkmann Inc., Elk Grove Village, Ill.). A challenge solution containing 350 ppm of palladium in toluene (prepared by dissolving 370 mg of palladium acetate into 500 g of toluene) was pumped through the holder containing the solid phase extraction media at a flowrate of 1.5 ml/min. Samples of the solution after passing through the solid phase extraction media were taken roughly every 5 minutes and analyzed on the UV-vis spectrophotometer to determine capture of the palladium. The results are shown in Table 4.

TABLE 4

| Time (minutes) | Palladium ppm |
|---|---|
| 10 | 0 |
| 20 | 0 |
| 30 | 12 |
| 40 | 28 |
| 50 | 51 |
| 60 | 77 |
| 70 | 121 |
| 80 | 145 |
| 85 | 156 |

As shown in Table 4 above, the palladium concentration remained below the 10% breakthrough level (<35ppm) for about the first 45 minutes. After 85 minutes, the breakthrough concentration had reached roughly 50% of the initial feed Pd concentration. The pooled effluent after 85 min had a palladium concentration of 53 ppm.

### Comparative Example A

The efficiency of loose particles removing metal ions was examined. 100 ml of a 350 ppm palladium solution in toluene was place in an Erlenmeyer flask. A magnetic stirrer was added and the flask was placed on a stir plate at setting #5 (model #365, available from VWR Inc.). In each of two trials, a given quantity of Particle 1 was added to the flask and the amount of metal removed was determined using UV-vis analysis and the previously generated palladium calibration curve (in toluene). One minute prior to sampling, the magnetic stirrer was turned off and the powder was allowed to settle. Roughly 1 ml of solution was drawn off with a disposable pipette for UV-vis analysis. After sampling, the magnetic stirrer was restarted at setting #5. After UV-vis analysis, the sample was returned to the flask from the cuvette.

In the first trial, 176 mg of Particle 1 (loose powder) was added to the flask. In a second trial 354.7 mg of Particle 1 (loose powder) was added to the flask. The results are shown in Table 5.

TABLE 5

| | |
|---|---|
| | Palladium |
| | concentration |
| Time | (ppm) |

| (minutes) | Trial 1 | Trial 2 |
|---|---|---|
| 0 | 350 | 350 |
| 4 | 317 | 211 |
| 10 | 276 | nm |
| 12 | nm | 155 |
| 20 | 242 | 140 |
| 35 | 255 | 149 |
| 50 | 243 | nm |

nm = not measured

As shown in Table 5 above, Trial 2, which used about double the amount of Particle 1 as compared to Trial 1, came to equilibrium more quickly and reached a lower final Pd concentration. Surprisingly, Trail 2, which used 354.7 mg of loose Particle 1, at equilibrium removed about 57% of the Pd, while Example 6, which used 322 mg of Particle 1 entrapped in the porous polymeric fiber matrix, removed about 85% of the Pd when the pooled effluent was analyzed. Also, in Example 6, roughly half the number of effluent fractions had palladium levels below 30 ppm.

Foreseeable modifications and alterations of this invention will be apparent to those skilled in the art without departing from the scope and spirit of this invention. This invention should not be restricted to the embodiments that are set forth in this application for illustrative purposes.

1. A low back-pressure, solid phase extraction media for removing dissolved metals in a liquid comprising:
a porous polymeric fiber matrix, comprising a plurality of fibers and a polymeric binder, and a particle comprising at least one of a thiol-containing moiety or a thiourea-containing moiety, wherein the particle is entrapped in the porous polymeric fiber matrix.

2. The low back-pressure, solid phase extraction media according to claim 1, wherein the polymeric binder does not substantially adhere to the particle.

3. The low back-pressure, solid phase extraction media according to claim 1, wherein the particle comprises a silica particle having the following thiol-containing moiety has the general formula:
—RSH
wherein R is an alkyl, alkenyl, aryl, or alkaryl group optionally comprising heteroatoms and/or other functional groups.

4. (canceled)

5. The low back-pressure, solid phase extraction media according to claim 1, wherein the low back-pressure solid phase extraction media has a differential back pressure of 1.5 psi (10.3 kPa) at a flowrate of 3 ml/cm².

6. The low back-pressure, solid phase extraction media according to claim 1, wherein the particle is mechanically entrapped in the porous polymeric fiber matrix.

7. The low back-pressure, solid phase extraction media according to claim 1, wherein the particle is at least 20% by weight relative to the weight of the solid phase extraction media.

8. (canceled)

9. The low back-pressure, solid phase extraction media according to claim 1, wherein the polymeric binder is less than 5% by weight relative to the weight of the fibers.

10. The low back-pressure, solid phase extraction media according to claim 1, wherein the fibers comprises at least one of a polyamide, a polyolefin, a polysulfone, and combinations thereof.

11. The low back-pressure, solid phase extraction media according to claim 1, wherein the polyolefin is a fibrillated polyethylene.

12. The low back-pressure, solid phase extraction media according to claim 1, wherein the porous polymeric fiber matrix further comprises fibers of glass.

13. The low back-pressure, solid phase extraction media according to claim 1, wherein the porous polymeric fiber matrix comprises at least two different fibers.

14. The low back-pressure, solid phase extraction sheet according to claim 1, wherein the low back-pressure solid phase extraction media has a thickness of at least 0.5 mm.

15. The low back-pressure, solid phase extraction sheet according to claim 1, wherein the low back-pressure solid phase extraction media has a thickness of at most 15 mm.

16. The low back-pressure, solid phase extraction media according to claim 1, wherein the low back-pressure solid phase extraction media is flexible.

17. The low back-pressure, solid phase extraction media according to claim 1, wherein the liquid is non-aqueous.

18. The low back-pressure, solid phase extraction media according to claim 1, wherein the metals comprise at least one of mercury, palladium, platinum, gold, silver, copper, and combinations thereof.

19. A method of removing metals dissolved in a liquid comprising:
(a) providing the low back-pressure, solid phase extraction media according to claim 1; and
(b) contacting the low back-pressure, solid phase extraction media with a liquid comprising a dissolved metal, wherein the metal is adsorbed and becomes bound to at least one of the porous polymeric fiber matrix and a particle.

20. The method according to claims 19, wherein the liquid is non-aqueous.

21. The method according to claim 19, wherein the metal comprises at least one of mercury, palladium, platinum, gold, silver, copper, and combinations thereof.

22. A method of making solid-phase extraction media comprising:
(a) dispersing fibers in water to form a first aqueous dispersion;
(b) adding a dispersed binder to the first aqueous dispersion;
(c) coagulating the binder onto the dispersed fibers to form a second aqueous dispersion;
(d) contacting the second aqueous dispersion with particles comprising at least one of a thiol-containing moiety or a thiourea-containing moiety to from a third aqueous dispersion; and
(e) removing the liquid from the third aqueous dispersion.
